(19) United States
(12) Patent Application Publication
(10) Pub. No.: US 2004/0058308 A1
(43) Pub. Date: Mar. 25, 2004

(54) Learning tiles

(76) Inventor: Cynthia C. Neal, Edgewater, MD (US)

Correspondence Address: Walter A. Reiter, III, Esq., 170 West Street, Annapolis, MD, 21404, US

(21) Appl. No.: 10/247,930

(22) Filed: Sep. 20, 2002

(51) Int. Cl. G09B 25/00

(52) U.S. Cl. 434/403

(57) ABSTRACT

An instructional device including a series of soft cushions imprinted with symbols useful to instruct students of all ages and abilities. The method of instructing students using the cushions for instructional purposes consists of individual cushions imprinted with letters of the alphabet, diphthongs, digraphs, phonetically linked consonants, words, pictures, numbers, mathematical signs, geometric shapes, geographic shapes or other symbols useful to familiarize students with those concepts or items. After use, the Learning Tiles would be stored in a reusable storage bag or container suitable for easy storage and safekeeping when not in use.

### FIELD OF THE INVENTION

The present invention relates to a set of soft and thick mats suitable for use as cushions, imprinted with letters, symbols and other educational and instructional information, capable of being held and displayed by an instructor to demonstrate and illustrate the appearance, meaning or concept imprinted on the tiles. The set is comprised of multiple individual tiles for each letter of the alphabet, unit number or educational symbol or drawing, or any combination or concept described herein. The tiles include a bag for neat and compact storage of all of the tiles for storage and protection.

### BACKGROUND OF THE INVENTION

U.S. Pat. No. 4,280,241 to Pfaff discloses a fabric covered foam book sized from small enough to be held in the hands of a small child to large enough to use as a piece of furniture. The Pfaff invention is not intended for instructing a class of students nor does it provide a sitting surface for students.

U.S. Pat. No. 4,590,112 to Plumridge discloses a padded play brick. This is a construction toy that is not intended for use as a visual aid for the instruction of numbers, letters and the like.

U.S. Pat. No. 4,505,265 to Cronenwett and U.S. Pat. No. 4,242,767 to McMullen disclose a plurality of items covered with fabric, imprinted with letters, numbers or other like symbols with a means for interconnecting the various items in the manner of an interlocking block play system. These are also construction toys and are not a visual aid useful for group instruction.

U.S. Pat. No. 5,491,851 to Alonso discloses a rest mat intended to be used for nap time that can be compactly folded and easily carried. Although this invention discloses a cushion, it is not a visual aid for instruction or learning.

U.S. Pat. No. 5,212,842 to Glydon discloses a padded floor covering with a means to interlock the pieces to form a continuous padded play surface. This invention combines a cushion with a construction toy, however, it does not provide any means for use as an instructional visual aid.

Various mats, pads, cushions or pillows provide solutions to the discomfort of students, but these objects can provide unwanted distraction to preschool and early elementary level students, frustrating the instructional intent of maintaining students' attention by moving to the floor.

Flash cards allow a teacher to both maintain face-to-face contact and display a visual aid. These conventional flash cards are not suitable for use with classes of more than a few students because of their small size. Flash cards also do not solve the issue of the comfort of the student.

Preschool and early elementary level teachers face the daunting task of introducing foundational concepts in learning, such as numbers and letters to students who, because of tender age or limited cognitive ability or attention span, are easily distracted. One disadvantage of this method is that the teacher and the students may be distracted by the discomfort associated with sitting on a hard or unsanitary floor for any length of time.

The devices of the traditional prior art are generally suitable for their limited, intended purpose, such as maintaining students' attention and instructing students in various subjects by using a prop or visual aids such as a handouts, tangible objects, blackboards or overhead projectors, there are oftentimes other considerations that influence the need for improved instructional methods.

Disadvantages of the traditional prior art are solved with the present invention by allowing a teacher to physically engage students by having the teacher literally get down to the students' level, i.e., sitting on a floor with the students. An advantage over the prior art of record allows an instructor to maintain face-to-face contact with a student without the distraction of discomfort due to hard or unsanitary surfaces or visual impairment.

Flash cards have long been an effective way to introduce and teach various concepts to preschool and elementary level students. The flash card is a visual, tangible display that concentrates the attention of the student directly on the symbol of instruction. The student is not likely to have any question about what the instructor is demonstrating because the symbol can be prominently and dominantly displayed in the direct view of the student.

The display of the educational symbol, the letter or the word on a flash card is superior to other methods such as a blackboard or a hand out in that there is little chance that the student's attention will be incorrectly focussed on the wrong symbol or another symbol on the blackboard or hand out.

A limitation of the use of flash cards is the small number of children that can be instructed with the flash card at any one time. This limitation makes the flash card suitable for one-on-one or very small group instruction but unsuitable for demonstration to groups of ten or twenty, such groups being the normal class size of the target student group.

Preschool and early elementary education classes are most effectively addressed by the instructor when all of the students have a direct, unimpeded view of the instructor and when the students are on the same level or close to the same level as the instructor. This technique typically and effectively arranges the students sitting along the circumference of a circle on the floor with the instructor also positioned at a low level on the circumference of the circle.

The traditional flash card displayed by the instructor in this position would not be visible to all students at all times because of the size and angle of display of the flash card. There also arises the issue of comfort of the students. An uncomfortable student will have difficulty focusing on the object of the lesson. It is an additional object of the invention to provide a mat for the student to use for sitting and like activities.

It is, therefore, an object of Learning Tiles to provide an instructional device that can function as a sitting cushion and a method of instructing students using the Learning Tiles. The Learning Tiles are useful to instruct students in letters, numbers, colors, shapes and other learning concepts, and also to provide a soft sitting mat which students could use to increase comfort while resting or sitting during instruction or at other times.

### SUMMARY OF THE INVENTION

The invention is an instructional device that is a series of soft cushions imprinted with symbols useful to instruct students of all ages and abilities as well as a method of instruction using these cushions. The symbols are individual letters of the alphabet, diphthongs, digraphs, phonetically linked consonants, words, pictures, numbers, mathematical signs or other symbols.

The symbols can be either imprinted upon a fabric cover of the cushioning material, imprinted directly onto the cushioning material, or the cushion itself can be shaped to represent the symbol or shape.

The cushions are large enough and thick enough to provide a comfortable pad for sitting and small enough to be easily displayed or held by an instructor, or can be made of any size, thickness, and shape desired.

### BRIEF DESCRIPTION OF THE DRAWINGS

The foregoing and other objects, aspects and advantages will be better understood from the following detailed description of preferred embodiments of the invention with reference to the drawings, in which:

FIG. 1 is a perspective diagram of an example of an individual Learning Tile showing the relative size, shape and dimension of the tile as well as a representative symbol imprinted on the face of the tile;

FIG. 2 is a similar view to FIG. 1 showing a second embodiment of the present invention;

FIG. 3 is a similar view to FIG. 1 showing a third embodiment of the present invention;

FIG. 4 is a similar view to FIG. 1 showing a fifth embodiment of the present invention in the form of a perspective cut-away view of the invention with “A” representing the padding and “B” representing the durable covering of the padding;

FIG. 5 is a view depicting a method of using the invention in an instructional classroom setting with the instructor displaying the tile imprinted with an educational symbol to a group of students sitting or reclining on other Learning Tiles;

FIG. 6 depicts a student sitting on a Learning Tile; and

FIG. 7 depicts an enclosure suitable for storing the Learning Tile set when not in use and a means for securing said enclosure.

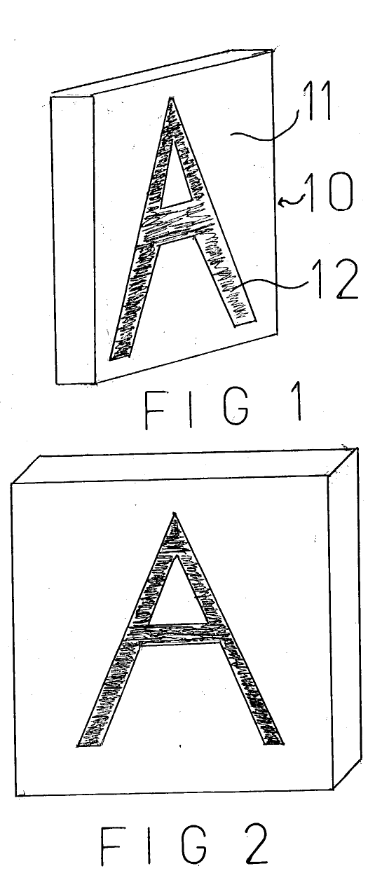

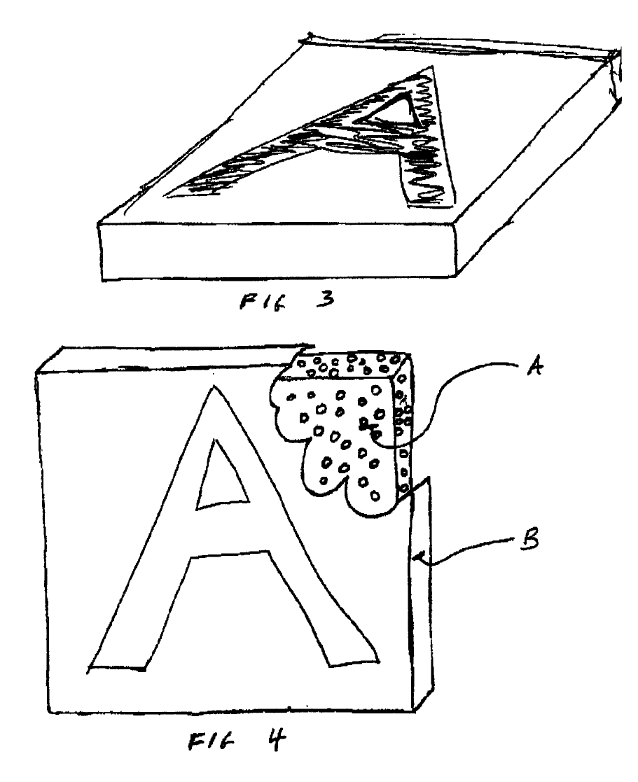

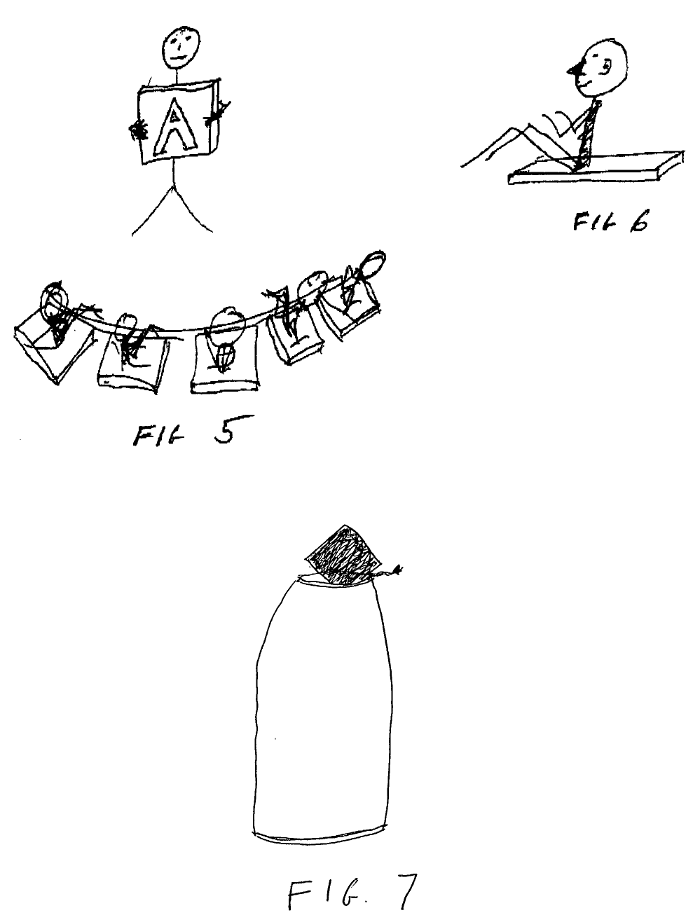

### DETAILED DESCRIPTION OF THE PREFERRED EMBODIMENTS

Referring now to the drawings, and particularly to FIG. 1, there is shown a front view of a Learning Tile 10 in the form of a planar panel 11 that can be made of fabric, polyvinyl chloride material, or the like.

The pad covering is sewn, mechanically fastened, chemically bound or heat welded to form a preferably continuous cover. Planar panel 11 includes printed indicia 12 in several forms including a letter of the alphabet, unit number or educational symbol or drawing, or any combination or concept described herein.

According to another aspect of the invention, Learning Tiles are square, rectangular or other geometric or geographic shaped pads covered with material. The various instructional shapes are imprinted on the cover. In another preferred embodiment, the instructional shape or figure is imprinted directly onto the pad and the Learning Tile is a single integral unit not covered with a separate material.

Yet another aspect of the present invention includes a set of Learning Tiles comprised of a number of individual tiles printed with a complete series of symbols permitting the instructor to demonstrate or display for students any number of individual instructional shapes, figures, or drawings.

A still further aspect of the present invention comprises a bag or container for the easy storage and safekeeping of a complete set of Learning Tiles.

According to one aspect of the invention, the present invention also comprises a method of instructing students using the Learning Tile teaching aid. One aspect of the method of using the Learning Tile teaching aid would allow an instructor to distribute individual Learning Tiles to an assembled group of students. The students could use the Learning Tiles as cushions. The instructor could display another Learning Tile for the assembled students' view and offer instruction regarding the displayed symbol. Students could also participate in the instruction by displaying a Learning Tile to others or to identify Learning Tiles being held by other students. Used in such manner, the instruction could proceed in such a “call and response” method both instructing and engaging students.

The objects of this invention are to provide a tangible display medium for the instruction of students by use of the Learning Tile. The Learning Tile is comprised of a cushioning material suitable to be used as a sitting mat. In one embodiment, the mat is encased in a durable material. A carrying handle is incorporated into the material. Imprinted onto the Learning Tile directly or onto the covering are useful instructional symbols, designs and themes.

The symbols imprinted on the Learning Tile include upper and lower case letters, diphthongs, phonetically linked consonants, words, punctuation marks, mathematical signs, numbers and the like. The concepts to be imprinted on the Learning Tile include historic figures, geographic representations such as continents, countries or states, place names, geometric shapes, colors and the like.

In addition to the preferred embodiment of square or rectangular shaped Learning Tiles, the tiles could also be configured as geometric or geographic shapes. In this embodiment the entire outline of the tile and not just the imprinted portion could be used as an instructional aid.

The Learning Tiles are sized to permit an instructor to easily display the tile to students seated nearby by holding the tile vertically in front of the teacher large enough for all students to clearly see the symbol or figure but small enough not to obstruct the student's view of the teacher's face. In one embodiment, the tile has an outside dimension of 12″ high by 12″ wide.

The padding material of which the tile is fabricated is thick enough to provide a comfortable pad upon which the student could sit. In one embodiment, the padding is approximately 1″ thick.

In another embodiment, the Learning Tiles include a tight fitting covering upon which is imprinted the instructional symbol. This covering is made of a fabric or a polyvinyl chloride material. The pad covering is sewn, mechanically fastened or heat welded to form a continuous cover.

The Learning Tiles are capable of being used individually or more effectively in a set that might contain the letters of the alphabet, upper and lower case, numbers 1 to 10 with mathematical function symbols, all states and capitals or the like. The individual tiles are distributed to the students or displayed in series by the instructor. The teacher uses the tiles to illustrate the concept displayed thereon and as a basis for instruction and/or discussion regarding the symbol.

While not in use for particular instruction, the students and/or teachers could use the tile as a comfortable sitting pad. After use, the tiles would be stored in a reusable storage bag or container constructed of fabric, mesh, webbing or other material suitable for containing the set of tiles.

While the invention has been described in terms of preferred embodiments, those skilled in the art will recognize that the invention can be practiced with modification within the spirit and scope of the appended claims.

I claim:

1. An instructional device comprising a series of soft cushions imprinted with individual letters of the alphabet, diphthongs, digraphs, phonetically linked consonants, words, pictures, numbers, mathematical signs or other symbols useful to familiarize students with those symbols.

2. An instructional device as in claim 1 wherein said symbols are imprinted upon a fabric cover dimensioned to encase said cushion in the manner of a slip cover.

3. An instructional device as in claim 1 wherein said cushion is comprised of foam or similar soft material.

4. An instructional device as in claim 1 dimensioned to provide a comfortable pad for sitting and to permit said cushion to be displayed or held by an instructor with a thickness of about between ½″ to 4″, and a surface area of around 12″×12″.

5. An instructional device as in claim 1 wherein said cushion is configured in a variety of shapes useful for illustrating said concepts of geometric shapes.

6. An instructional device as in claim 1 wherein said cushion is configured in a variety of irregular shapes useful for illustrating shapes of geographic features.

7. An instructional device comprising a series of said soft cushions including an enclosure for easy storage and safekeeping when not in use.

8. An instructional device as in claim 7 wherein, after use, said tiles would be stored in a reusable storage bag or container constructed of fabric, mesh, webbing or other material suitable for containing said set of tiles.

9. An instructional device as in claim 7 wherein said enclosure includes means for securing said enclosure.

10. A method of instructing students using a series of soft cushions for instructional purposes consisting of individual cushions imprinted with letters of the alphabet, diphthongs, digraphs, phonetically linked consonants, words, pictures, numbers, mathematical signs, geometric shapes, geographic shapes or other symbols useful to familiarize students with those concepts or items.
